(19) United States
(12) Patent Application Publication
(10) Pub. No.: US 2019/0314805 A1
(43) Pub. Date: Oct. 17, 2019

(54) A PROCESS FOR PRODUCING A CATALYST COMPRISING AN INTERMETALLIC COMPOUND AND A CATALYST PRODUCED BY THE PROCESS

(71) Applicants: BASF SE, Ludwigshafen am Rhein (DE); The Regents of the University of California, Oakland, CA (US)

(72) Inventors: Peter LEIDINGER, Ludwigshafen am Rhein (DE); Sven TITLBACH, Heidelberg (DE); Stephan A. SCHUNK, Heidelberg (DE); Andreas HAAS, Ludwigshafen am Rhein (DE); Paul ALIVISATOS, Berkeley, CA (US); Jacob KANADY, Irvine, CA (US)

(21) Appl. No.: 16/343,245

(22) PCT Filed: Oct. 18, 2017
(86) PCT No.: PCT/EP2017/076586

§ 371 Date: Apr. 18, 2019

(30) Foreign Application Priority Data
Oct. 20, 2016 (EP) 16194796.5

(51) Int. Cl. B01J 37/08; B01J 23/58; B01J 35/00; B01J 37/04; B01J 37/06

(52) U.S. Cl. CPC B01J 37/08; B01J 23/58; B01J 35/0013; B01J 2523/828; B01J 37/04; B01J 37/06; B01J 2523/23; B01J 35/006

(57) ABSTRACT

The invention relates to a process for producing a catalyst comprising an intermetallic compound comprising following steps: (a) Dissolving a metal selected from the group consisting of Li, Na, Ca, Sr, Ba, Eu and Yb in liquid ammonia, (b) Adding nanoparticles comprising a metal selected from the group consisting of Co, Rh, Ir, Ni, Pd, Pt, Cu, Ag, Au and Ru or a halide of at least one of these metals and an inorganic salt to the solution obtained in step (a), (c) Removing the liquid ammonia, (d) Annealing the mixture of step (c) at a temperature in the range between 200° C. and the melting temperature of the intermetallic compound wherein the intermetallic compound is formed, (e) Washing the intermetallic compound achieved in step (d). The invention further relates to a catalyst obtained by the process.

The invention relates to a process for producing a catalyst comprising an intermetallic compound comprising a metal selected from the group consisting of Co, Rh, Ir, Ni, Pd, Pt, Cu, Ag, Au and Ru, and a metal selected from the group consisting of Li, Na, Ca, Sr, Ba, Eu and Yb. The invention further relates to a catalyst comprising a support and an intermetallic compound, wherein the intermetallic compound is in the form of nanoparticles and is deposited on the surface of the support and in macropores, mesopores and micropores of the support.

Platinum-containing catalysts are for example applied in proton exchange membrane fuel cells (PEMFCs). Proton exchange membrane fuel cells are applied for an efficient conversion of stored chemical energy to electric energy. It is expected that future applications of PEMFCs are in particular mobile applications. For electrocatalysts, typically carbon-supported platinum nanoparticles are used. Especially on the cathode of a PEMFC, high amounts of the scarce and expensive metal platinum are required for a sufficient activity in the oxygen reduction reaction. An increased platinum-mass related activity can be realized by alloying platinum with a second metal like cobalt, nickel or copper. Such catalysts are described for example by Z. Liu et al., “Pt Alloy Electrocatalysts for Proton Exchange Membrane Fuel Cells: A Review”, Catalysis Reviews: Science and Engineering, 55 (2013), pages 255 to 288. However, as shown by I. Katsounaros et al., “Oxygen Electrochemistry as a Cornerstone for Sustainable Energy Conversion”, Angew. Chem. Int., Ed. 53 (2014), pages 102 to 121, under fuel cell conditions the second metal leaches out into the electrode. As a consequence, the activity decreases. In addition, the membrane is poisoned by the dissolved metal ions, lowering the overall performance of the PEMFC.

A possible process for producing intermetallic compounds of platinum and yttrium is described by P. Hernandez-Fernandez et al., “Mass-selected nanoparticles of Pt_{X}Y as model catalysts for oxygen electroreduction”, Nature Chemistry 6 (2014), pages 732 to 738. However, this process that is carried out in the gas phase only allows producing very small amounts. There is no synthesis known for nanoparticles containing an intermetallic compound of Co, Rh, Ir, Ni, Pd, Pt, Cu, Ag, Au or Ru as first metal and Li, Na, Ca, Sr, Ba, Eu and Yb as second metal which allows production of sufficient amounts for industrial applications and which can be operated economically. It is a further disadvantage of the process as shown by P. Hernandez-Fernandez that it is impossible to place the produced nanoparticles into the macropores and mesopores of a catalyst support. The nanoparticles produced in the gas phase are deposited only on the outer surface of the support.

A synthetic approach for the synthesis of the intermetallic compounds Pt₃Ti and Pt₃V was shown by Z. Cui et al., “Synthesis of Structurally Ordered Pt₃Ti and Pt₃V Nanoparticles as Methanol Oxidation Catalysts”, Journal of the American Chemical Society 136 (2014), pages 10206 to 10209. As metal precursors the chlorides PtCl₄, and TiCl₄ or VCl₃ and as reducing agent potassium triethylborohydride were used. During reduction in tetrahydrofuran, KCl was formed and precipitated. Due to its insolubility in tetrahydrofuran, it acts as stabilizer against sintering of the nanoparticle intermediates during subsequent thermal treatment at about 700° C.

A process for producing intermetallic compounds comprising Pd and Eu or Yb has been described by H. Imamura et al., “Hydrogenation on Supported Lanthanide-Palladium Bimetallic Catalysts: Appearance of Considerable Hydrogen Uptake”, Bull. Chem. Soc. Jpn, Vol. 69, 1996, pages 325 to 331. In the process Eu or Yb are dissolved in liquid ammonia and mixed with a base catalyst comprising Pd on a support. According to this document hydrogen uptake in a hydrogenation reaction only has been shown when SiO₂ or Al₂O₃ have been used as support. In H. Imamura et al., “Lanthanide metal overlayers by deposition of lanthanide metals dissolved in liquid ammonia on Co and Ni. Effects of particle sizes of parent Co and Ni metals”, Catalysis Letters 32, 1995, pages 115 to 122 production of an intermetallic compound of Co or Ni with Eu or Yb as catalyst has been described. In the process for producing the catalyst the Eu or Yb also has been dissolved in ammonia. The produced intermetallic compound had the form of an overlayer. The production of an intermetallic compound comprising Cu or Ag and Yb using liquid ammonia metal solution of ytterbium has been described in H. Imamura et al., “Alloying of Yb—Cu and Yb—Ag utilizing liquid ammonia metal solution of ytterbium”, Journal of solid state chemistry 171, 2003, pages 254 to 256. In the disclosed process an Yb—Cu and Yb—Ag intermetallic film on Cu and Ag, respectively, were formed.

In a study comparing bulk electrodes in the oxygen reduction reaction, M. Escudero-Escribano et al. “Tuning the activity of Pt alloy electrocatalysts by means of the lanthanide contraction”, Science 352 (2016) 73-76 identified Pt₅Ca as highly active and stable catalyst.

It is a disadvantage of several processes that the intermetallic compound cannot be formed as nanoparticles which have an increased surface area that affords higher reaction rates compared to the intermetallic compounds in the forms as known from the art. A disadvantage of processes which allow production of nanoparticles is that organic ligands (aka surfactants) are used in the process. The ligand could block the surface of the nanoparticle and decrease catalytic activity.

Further, most of the processes have the disadvantage that it is not possible to economically produce larger amounts in an industrial scale.

Therefore, it is an object of the present invention to provide a process for producing an intermetallic compound that can be operated economically and allows production of the intermetallic compound in the form of nanoparticles in industrial scale.

This object is achieved by a process for producing a catalyst comprising an intermetallic compound comprising following steps:

(a) Dissolving a metal selected from the group consisting of Li, Na, Ca, Sr, Ba, Eu and Yb in liquid ammonia,

(b) Adding nanoparticles comprising a metal selected from the group consisting of Co, Rh, Ir, Ni, Pd, Pt, Cu, Ag, Au and Ru or a halide of at least one of these metals and an inorganic salt to the solution obtained in step (a),

(c) Removing the liquid ammonia,

(d) Annealing the mixture of step (c) at a temperature in the range between 200° C. and the melting temperature of the intermetallic compound wherein the intermetallic compound is formed,

(e) Washing the intermetallic compound achieved in step (d).

The inventive process allows production of intermetallic compounds of a metal selected from the group consisting of Co, Rh, Ir, Ni, Pd, Pt, Cu, Ag, Au and Ru with a metal which is soluble in ammonia where only small amounts of by-products are formed which easily can be washed off or even without producing undesired by-products. A further advantage of the inventive process is that after evaporation of ammonia a very fine powder of the pure metals without any oxide impurities is achieved. The intimate mixture of the achieved pure metal powder could easily be transformed to intermetallic compounds via thermal treatment. Additionally, no organic compounds or solvents are used in any step of the process and it is possible to control over particle size by simple variation in the amount of KCl or NaCl added. Further, by the inventive process it is possible to access intermetallic nanoparticles and all intermetallic compounds can be produced relatively straightforward to increase scale.

To produce the intermetallic compound in a first step, the metal selected from the group consisting of Li, Na, Ca, Sr, Ba, Eu and Yb is dissolved in liquid ammonia. As ammonia is gaseous at ambient pressure and ambient temperature, the dissolving is carried out at a temperature in the range between the melting point and the boiling point of the ammonia.

After dissolving the metal selected from the group consisting of Li, Na, Ca, Sr, Ba, Eu and Yb nanoparticles comprising a metal selected from the group consisting of Co, Rh, Ir, Ni, Pd, Pt, Cu, Ag, Au and Ru or a halide of at least one of these metals and an inorganic salt are added to the solution. The inorganic salt is used to avoid agglomeration of the nanoparticles particularly during the following annealing step. The nanoparticles and the inorganic salt can be added as separate components. However, it is preferred to add a composition comprising the nanoparticles and the inorganic salt. By adding a composition comprising the nanoparticles and the inorganic salt, the nanoparticles already are stabilized in the composition. Particularly preferred, the nanoparticles are embedded in a matrix of the inorganic salt.

As the nanoparticles or the halide and the inorganic salt are added to the solution achieved in step (a) comprising ammonia and the metal selected from the group consisting of Li, Na, Ca, Sr, Ba, Eu and Yb, the addition of the nanoparticles and the inorganic salt also is performed at a temperature in the range between the melting point and the boiling point of the ammonia.

As the melting point and the boiling point depend on the pressure, it is possible to carry out the process steps (a) and (b) at elevated pressure to allow performing these steps at a temperature that is higher than the boiling point of ammonia at ambient pressure. However, it is preferred to perform steps (a) and (b) at ambient pressure and at a temperature between the melting point and the boiling point of ammonia at ambient pressure. Preferably, steps (a) and (b) are carried out at ambient pressure and a temperature in the range between −77° C. and −33° C.

It is possible to perform steps (a) and (b) at different conditions. However, it is preferred, to perform steps (a) and (b) at the same pressure, particularly at ambient pressure. In this case temperature differences between steps (a) and (b) preferably only result from adding components or possible reactions. However, to keep the temperature constant it is possible to temper the container into which ammonia, metal selected from the group consisting of Li, Na, Ca, Sr, Ba, Eu and Yb, the nanoparticles and the inorganic salt are added. It is particularly preferred to perform steps (a) and (b) at ambient pressure and constant temperature.

The inorganic salt which is added in step (b) preferably is inert, which means that the salt does not react chemically with any of the compounds added in steps (a) and (b). Suitable salts are for example halides of alkali metals and alkali earth metals. Of these halides of Na and K are preferred. Particularly preferred as inorganic salts are KCl and NaCl.

As generally supported catalysts are used, it is preferred to add a support before carrying out step (c) or in step (e) to achieve a supported catalyst comprising the support and the intermetallic compound, wherein the intermetallic compound is in the form of nanoparticles deposited on the surface of the support and in the pores of the support. The pores of the support in which the nanoparticles of the intermetallic compound are deposited are macropores, mesopores and micropores. In this context macropores are pores having a diameter of more than 50 nm, mesopores are pores having a diameter in the range from 2 to 50 nm and micropores are pores having a diameter of less than 2 nm. The amount of the support that is added preferably is in the range from 1 to 99 wt %, more preferably 10 to 90 wt %, and particularly preferred 24 to 85 wt. % based on the total mass of all solids added in step (a) and the support.

If the support is added before carrying out step (c), it is possible to add the support before dissolving the metal selected from the group consisting of Li, Na, Ca, Sr, Ba, Eu and Yb, during dissolving the metal selected from the group consisting of Li, Na, Ca, Sr, Ba, Eu and Yb or after dissolving the metal selected from the group consisting of Li, Na, Ca, Sr, Ba, Eu and Yb and before adding the nanoparticles and the inert salt. Further, it is also possible to add the support together with the nanoparticles and the inert salt or even after adding the nanoparticles and the inert salt.

It is possible to add the total amount of support at once or to add parts of the support at different times. However, it is preferred to add the total amount of support at once. Preferably the support is added prior to step (c), more preferably prior to step (b). In other embodiments, the support may be added after step (d) and more preferably after step (e).

Preferably, the metal selected from the group consisting of Co, Rh, Ir, Ni, Pd, Pt, Cu, Ag, Au and Ru is one of platinum, silver, rhodium, iridium, palladium or gold. Particularly the metal selected from the group consisting of Co, Rh, Ir, Ni, Pd, Pt, Cu, Ag, Au and Ru is platinum.

The metal selected from the group consisting of Li, Na, Ca, Sr, Ba, Eu and Yb preferably is Yb,Ba,Sr,Ca, more preferably Ba, Sr, Ca, much more preferably Sr, Ca, most preferably Ca.

The amount of the metal selected from the group consisting of Li, Na, Ca, Sr, Ba, Eu and Yb in the final intermetallic compound preferably is in the range from 16.667 to 50 mol %, more preferred in the range from 16.67 to 33.33 mol %, each based on the total amount of metal selected from the group consisting of Li, Na, Ca, Sr, Ba, Eu and Yb and the metal selected from the group consisting of Co, Rh, Ir, Ni, Pd, Pt, Cu, Ag, Au and Ru.

As added in step (a), the amount of the metal selected from the group consisting of Li, Na, Ca, Sr, Ba, Eu and Yb preferably is in the range from 0.2 to 20 molar ratio, more preferred in the range from 2.5 to 10 molar ratio with respect to the amount of nanoparticles or halide salt of the metal selected from the group consisting of Co, Rh, Ir, Ni, Pd, Pt, Cu, Ag, Au and Ru added in step (b).

As added in step (b), the amount of inert salt preferably is in the range from 1 to 200 molar ratio, more preferred in the range from 4 to 160 molar ratio with respect to the amount of nanoparticles or halide salt of the metal selected from the group consisting of Co, Rh, Ir, Ni, Pd, Pt, Cu, Ag, Au and Ru added in step (b).

As added in step (a) the amount of the metal selected from the group consisting of Li, Na, Ca, Sr, Ba, Eu and Yb preferably is in the range from 0.001 to 20 molar ratio, more preferred in the range from 0.015 to 2.5 molar ratio with respect to the amount of inert salt.

After dissolving the metal selected from the group consisting of Li, Na, Ca, Sr, Ba, Eu and Yb and adding the nanoparticles or the halide and the inert salt, the mixture preferably is stirred for 10 to 60 min.

Further it is also preferred to stir the solution comprising ammonia and the metal selected from the group consisting of Li, Na, Ca, Sr, Ba, Eu and Yb while adding the nanoparticles or the halide and the inert salt.

The dissolving of the metal selected from the group consisting of Li, Na, Ca, Sr, Ba, Eu and Yb in ammonia also preferably is carried out while stirring.

For carrying out steps (a) and (b) any suitable device can be used in which the metal selected from the group consisting of Li, Na, Ca, Sr, Ba, Eu and Yb can be dissolved in ammonia and the nanoparticles or the halide and the inert salt is added. Suitable devices for example are continuous stirred tank reactors, wherein any suitable stirrer known to a skilled person can be used.

After dissolving the metal selected from the group consisting of Li, Na, Ca, Sr, Ba, Eu and Yb in ammonia and adding the nanoparticles or the halide and the inert salt, the liquid ammonia is removed. For removing the liquid ammonia it is possible to heat the mixture to a temperature above the boiling point of ammonia and thus evaporate the ammonia. Preferably the ammonia is removed under vacuum. The temperature at which the ammonia is removed, preferably is in the range from −33 to 115° C. For removing most of the ammonia it is possible to carry out the removal stepwise by alternating setting vacuum and venting preferably with an inert gas. Alternatively or additionally it is possible to heat and cool the mixture alternating. Particularly preferred the ammonia is removed by vacuum at a temperature between −77° C. to 115° C. “Vacuum” in context of this step means a pressure of less than 0.1 mbar (abs). In a preferred embodiment the ammonia is removed by firstly thaw the mixture to room temperature under vacuum and then heat to a temperature in the range from room temperature to 115° C., preferably in the range from 100° C. to 115° C. and particularly preferably in the range from 110 to 115° C. The heating is performed with a heating gradient from 0.1 K/min to 10 K/min to avoid formation of undesired by-products, particularly nitrides.

In a next step the mixture freed from ammonia is annealed at a temperature in the range between 200° C. and the melting temperature of the intermetallic compound wherein the intermetallic compound is formed. The annealing preferably is carried out at a temperature in the range between 400 and 700° C. The pressure at which the annealing is carried out preferably is below 0.15 mbar, particularly preferably below 0.05 mbar. The duration of the heating step preferably is from 1 to 1200 min, more preferred in the range from 60 to 1020 min and particularly preferred in the range from 180 to 420 min.

For annealing it is either possible to fill the mixture obtained in step (c) into a heated oven or to heat the mixture in a heating device until the preset temperature for the annealing step is reached. If the mixture is heated until a preset temperature is reached, the annealing is carried out either continuously with 2 to 14° C./min ramp rate or stepwise, for example raising the temperature 40 to 60° C., hold the temperature for 2 to 30 min and repeated until the preset temperature is reached. In a preferred embodiment, the mixture is heated to a preset temperature with a continuous ramp rate of 4 to 8° C./min.

During annealing the intermetallic compound is formed. Depending on the metals used, the intermetallic compound comprises a metal selected from the group consisting of Co, Rh, Ir, Ni, Pd, Pt, Cu, Ag, Au and Ru and a metal selected from the group consisting of Li, Na, Ca, Sr, Ba, Eu and Yb. Preferably the intermetallic compound comprises a metal selected from platinum, silver, rhodium, iridium, palladium or gold and a metal selected from calcium, Sr, Ba, Yb. Particularly preferably the intermetallic compound is one of Pt with Ca.

As it generally cannot be avoided that by-products are formed and as further the inert salt should be removed, after annealing the achieved intermetallic compound is washed with water or an aqueous acid. The washing medium preferably is either water or an aqueous solution of an acid.

Acids which can be used are for example sulfuric acid, hydrochloric acid, sulfonic acid, methane sulfonic acid, phosphoric acid, phosphonic acid, acetic acid, citric acid, nitric acid, and perchloric acid. A preferred acid is sulfuric acid. The washing can be carried out once or repeatedly. If at least one aqueous acid is used for washing after washing the mixture with an aqueous acid an additional washing with water is performed to remove the acid.

To reduce the formation of by-products it is preferred to carry out at least steps (a) to (d) in an inert atmosphere. An inert atmosphere in this context means that no components are contained which may react with any of the components of the intermediate product. Such components are for example oxygen or oxygen comprising substances for example water. Particularly preferable as inert atmosphere are nitrogen, argon, methane or vacuum.

For the washing step (e) it is possible but not necessary to use an inert atmosphere. The washing in step (e), therefore, preferably is performed in air. This allows usage of less complex apparatus for the washing.

All steps for producing the intermetallic compound can be carried out continuously or batchwise.

By the inventive process a catalyst is produced which comprises a support and an intermetallic compound comprising a metal selected from the group consisting of Co, Rh, Ir, Ni, Pd, Pt, Cu, Ag, Au and Ru, and a metal selected from the group consisting of Li, Na, Ca, Sr, Ba, Eu and Yb, wherein the intermetallic compound is in the form of nanoparticles and is deposited on the surface of the support and in macropores, mesopores and micropores of the support.

In a preferred embodiment, the intermetallic compound comprises platinum and calcium, platinum and strontium, platinum and barium, platinum and ytterbium, platinum and europium, or silver and calcium.

The supported catalyst generally has an amount of platinum between 1 and 50 wt-% based on the total mass of the supported catalyst. The nanoparticles of the intermetallic compound preferably have a diameter below 100 nm, more preferred in the range from 1 nm to 50 nm, preferably in the range from 1 nm to 25 nm and particularly preferred in the range from 1 nm to 20 nm.

The support that is used for the catalyst can be any porous support known for use with catalysts. Preferably, a support is used which is porous and has a BET surface of at least 4 m²/g. Preferably the BET surface is in the range from 20 to 1000 m²/g and particularly preferred in the range from 70 to 300 m²/g.

The material for the support can be a metal oxide or carbon. If a metal oxide is used, the metal oxides generally are ceramics. Suitable metal oxides are for example mixed oxides like antimony tin oxide, aluminum oxide, silicon oxide or titanium oxide. Preferred are ceramics containing more than one metal or mixed oxide. However, carbon supports are particularly preferred. Suitable carbon supports for example are carbon black, activated carbon, graphenes and graphite.

The catalyst preferably can be used as an electrocatalyst, particularly as a cathode catalyst, for fuel cells. Particularly, the catalyst is used in proton exchange membrane fuel cells.

### Example 1 (Pt₂Ca)

All procedures until washing were performed under inert conditions. In detail, 42 mg of Ca (99.5% metals basis) was dissolved in 10 mL of liquid ammonia (99.99%, anhydrous) at −77° C. under stirring. Afterwards, a mixture containing Pt nanoparticles exhibiting less than 10 nm in mean diameter with four equivalents of dry KCl was added quickly as a powder over flowing argon to the ammonia solution. After 20 minutes of stirring the ammonia was evaporated. The remaining powder was dried under active vacuum at about 0.1 mbar for 20-30 minutes and heated slowly to 70° C. in a heating mantle. The temperature was slowly increased to 110° C. in 10° C. increments, each increment with a duration of 10 minutes, and kept at 110° C. for 6 hours to fully remove any remaining ammonia. Afterwards, the powder was calcined at 700° C. for 210 minutes under static vacuum of about 0.1 mbar. The remaining powder was washed with water under air until the pH of the washing water was in the range of 6 to 7.5.

The powder was characterized by X-ray diffraction spectroscopy (XRD) and transmission electron microscopy (TEM) indicating phase pure Pt₂Ca nanoparticles.

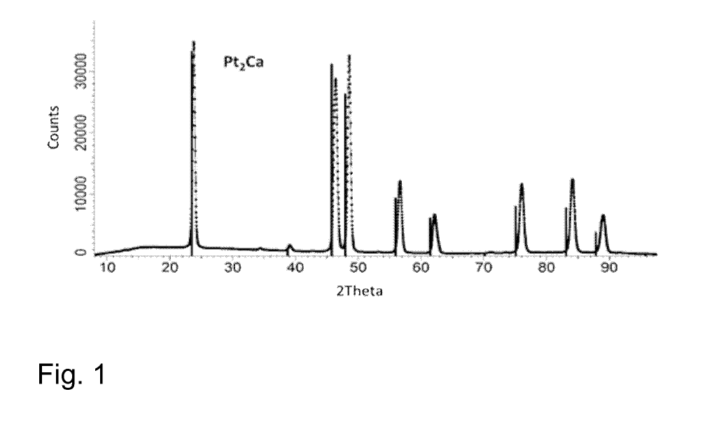

FIG. 1 shows an XRD spectrograph of the obtained Pt₂Ca nanopowder.

In comparison with library data that is represented by the bars in FIG. 1, it can be seen that Pt₂Ca with high purity is obtained.

### Example 2 (Pt₂Eu)

All procedures until washing were performed under inert conditions. In detail, 43 mg of Eu was dissolved in 10 mL of liquid ammonia (99.99%, anhydrous) at −77° C. under stirring. Afterwards, a mixture containing Pt nanoparticles exhibiting less than 10 nm in mean diameter with four equivalents of dry KCl was added quickly as a powder over flowing argon to the ammonia solution. After 20 minutes of stirring the ammonia was evaporated. The remaining powder was dried under active vacuum at about 0.1 mbar for 20-30 minutes and heated slowly to 70° C. in a heating mantle. The temperature was slowly increased to 110° C. in 10° C. increments, each increment with a duration of 10 minutes, and kept at 110° C. for 6 hours to fully remove any remaining ammonia. Afterwards, the powder was calcined at 700° C. for 210 minutes under static vacuum of about 0.1 mbar. The remaining powder was washed with water under air until the pH of the washing water was in the range of 6 to 7.5.

The powder was characterized by X-ray diffraction spectroscopy which proved the formation of Pt₂Eu nanoparticles.

### Example 3 (PtYb)

All procedures until washing were performed under inert conditions. In detail, 57 mg of Yb was dissolved in 10 mL of liquid ammonia (99.99%, anhydrous) at −77° C. under stirring. Afterwards, a mixture containing Pt nanoparticles exhibiting less than 10 nm in mean diameter with four equivalents of dry KCl was added quickly as a powder over flowing argon to the ammonia solution. After 20 minutes of stirring the ammonia was evaporated. The remaining powder was dried under active vacuum at about 0.1 mbar) for 20-30 minutes and heated slowly to 70° C. in a heating mantle. The temperature was slowly increased to 110° C. in 10° C. increments, each increment with a duration of 10 minutes, and kept at 110° C. for 6 hours to fully remove any remaining ammonia. Afterwards, the powder was calcined at 700° C. for 210 minutes under static vacuum of about 0.1 mbar. The remaining powder was washed with water under air until the pH of the washing water was in the range of 6 to 7.5.

The powder was characterized by X-ray diffraction spectroscopy which proved the formation PtYb nanoparticles.

1. A process for producing a catalyst comprising an intermetallic compound, the process comprising following steps:
(a) Dissolving a metal selected from the group consisting of Li, Na, Ca, Sr, Ba, Eu and Yb in liquid ammonia,
(b) Adding nanoparticles comprising a metal selected from the group consisting of Co, Rh, Ir, Ni, Pd, Pt, Cu, Ag, Au and Ru or a halide of at least one of these metals and an inorganic salt to the solution obtained in step (a),
(c) Removing the liquid ammonia,
(d) Annealing the mixture of step (c) at a temperature in the range between 200° C. and the melting temperature of the intermetallic compound wherein the intermetallic compound is formed, and
(e) Washing the intermetallic compound achieved in step (d).

2. The process according to claim 1, wherein in step (b) a composition comprising the nanoparticles and the inorganic salt is added.

3. The process according to claim 2, wherein the nanoparticles are embedded in a matrix of the inorganic salt.

4. The process according to claim 1, wherein in step (b) a mixture comprising the halide and the inorganic salt is added.

5. The process according to claim 1, wherein the inorganic salt is selected from the group consisting of halides of alkali metals and earth alkali metals.

6. The process according to claim 1, wherein a support is added before carrying out step (c) or in step (e) to achieve a supported catalyst comprising the support and the intermetallic compound.

7. The process according to claim 1, wherein steps (a), (b) and (d) are carried out in an inert atmosphere.

8. The process according to claim 1, wherein the metal selected from the group consisting of Co, Rh, Ir, Ni, Pd, Pt, Cu, Ag, Au and Ru is platinum, silver, rhodium, iridium, palladium or gold.

9. The process according to claim 1, wherein the washing in step (e) is carried out with water or an aqueous solution of an acid.

10. A catalyst produced by the process according to claim 1, wherein the catalyst comprises a support and an intermetallic compound comprising a metal selected from the group consisting of Co, Rh, Ir, Ni, Pd, Pt, Cu, Ag, Au and Ru, and a metal selected from the group consisting of Li, Na, Ca, Sr, Ba, Eu and Yb, wherein the intermetallic compound is in the form of nanoparticles and is deposited on the surface of the support and in macropores, mesopores and micropores of the support.

11. The catalyst according to claim 10, wherein the intermetallic compound comprises Pt and Yb, Pt and Eu, Pt and Sr, Pt and Ba, Pt and Ca, or Ag and Ca.

12. The catalyst according to claim 10, wherein the support is a porous support having a BET surface of at least 4 m²/g.

13. The catalyst according to claim 10, wherein the support is a metal oxide or carbon.

14. The catalyst according to claim 10, wherein the support is selected from the group consisting of carbon black, activated carbon, graphenes and graphite.

15. The catalyst according to claim 10, wherein the intermetallic compound is Pt₅Ca or Pt₂Ca
